(19) United States
(12) Patent Application Publication
(10) Pub. No.: US 2018/0188592 A1
(43) Pub. Date: Jul. 5, 2018

(54) COLOR FILTER SUBSTRATE, LIQUID CRYSTAL PANEL AND LIQUID CRYSTAL DISPLAY

(71) Applicant: Wuhan China Star Optoelectronics Technology Co., Ltd., Wuhan, Hubei (CN)

(72) Inventor: Haibo PENG, Shenzhen, Guangdong (CN)

(73) Assignee: Wuhan China Star Optoelectronics Technology Co., Ltd., Wuhan, Hubei (CN)

(21) Appl. No.: 15/308,333

(22) PCT Filed: Oct. 10, 2016
(86) PCT No.: PCT/CN2016/101625

§ 371 Date: Nov. 1, 2016

(30) Foreign Application Priority Data
Sep. 7, 2016 (CN) 201610807414.4

(51) Int. Cl. G02F 1/1335; G02F 1/1339; G02F 1/1368

(52) U.S. Cl. CPC G02F 1/133514; G02F 1/133512; G02F 2202/103; G02F 1/1368; G02F 1/13394

(57) ABSTRACT

A color filter substrate includes a substrate, a red subpixel, a green subpixel, a blue subpixel and a white subpixel disposed on the substrate. The red subpixel, the green subpixel and the blue subpixel display a first white image, the white subpixel displays a second white image. A white chromaticity coordinate of the first white image and that of the second white image are identified. The disclosure can identify the white chromaticity coordinate of the white image displayed by the white subpixel of the RGBW display panel and that by the red subpixel, the green subpixel and the blue subpixel of the RGBW display panel, so that a color temperature drift degree of the white image displayed by the RGBW display panel and that of the white image display by the original RGB display panel are identified, for improving a display effect of the RGBW display panel.

### TECHNICAL FIELD

The disclosure relates to a liquid crystal display technical field, and more particularly to a color filter substrate, a liquid crystal panel and a liquid crystal display.

### DESCRIPTION OF RELATED ART

At present, in a display device with a liquid crystal panel, a pixel is mostly formed by a red (R) subpixel, a green (G) subpixel and a blue (B) subpixel. A color required by a display panel to display a color image is mixed by controlling grayscale data of each of the subpixels.

Various requirements with regard to the display panel are increasing with the development of information technology, high transmittance, low power consumption and a high qualified image have become the requirements with regard to the display panel. The transmittance of a conventional RGB tricolor mixing light display manner and efficiency for mixing light are both relatively low, which lead to considerable power consumption of the display panel, further restricting optimization of the display panel. Accordingly, a display panel with a pixel consisting of a red (R) subpixel, a green (G) subpixel, a blue (B) subpixel and a white (W) subpixel for improving display quality of a RGB display panel. However, in a RGBW display panel, color inaccuracy of a white image displayed by the RGBW display panel in various grey levels will be increased due to addition of the white (W) subpixel, which affects a display performance and spread of the RGBW display panel.

### SUMMARY

In order to solve the problem in the prior art, an objective of the disclosure is to provide a color filter substrate, including a substrate, a red subpixel, a green subpixel, a blue subpixel and a white subpixel. The red subpixel, the green subpixel, the blue subpixel and the white subpixel are disposed on the substrate. The red subpixel, the green subpixel and the blue subpixel display a first white image, the white subpixel displays a second white image. A white chromaticity coordinate of the first white image and a white chromaticity coordinate of the second white image are identified.

Furthermore, the red subpixel is formed by a red photo resistor, the green subpixel is formed by a green photo resistor, the blue subpixel is formed by a blue photo resistor, and the white subpixel is formed by a white photo resistor or a transparent photo resistor.

Furthermore, when the white subpixel is formed by the white photo resistor, the white chromaticity coordinates of the first white image and the second white image are both (0.3, 0.32).

Furthermore, when the white subpixel is formed by the transparent photo resistor, the white chromaticity coordinates of the first white image and the second white image are both (0.28, 0.29).

Furthermore, the color filter substrate further includes black matrixes formed between any two adjacent subpixels. The two subpixels include any two of the red subpixel, the green subpixel, the blue subpixel and the white subpixel.

Furthermore, the color filter substrate further includes a conductive film layer, covering the red subpixel, the green subpixel, the blue subpixel, the white subpixel and the black matrixes.

Furthermore, the color filter substrate further includes photo spacers, disposed on the conductive film layer opposite to the black matrixes.

Another objective of the disclosure is to provide a liquid crystal panel, including an array substrate and a color filter substrate that are aligned, the color filter substrate is the color filter substrate above.

Furthermore, the array substrate is an amorphous silicon thin film transistor array substrate or a low temperature poly-silicon thin film transistor array substrate.

Another objective of the disclosure is to provide a liquid crystal display, including a backlight module and a liquid crystal panel disposed opposite, the liquid crystal panel is the liquid crystal panel above.

Beneficial effects of the disclosure are as follows. The disclosure identifies the white chromaticity coordinate of the white image displayed by the white subpixel of the RGBW display panel and the white chromaticity coordinate of the white image displayed by the red subpixel, the green subpixel and the blue subpixel of the RGBW display panel, so that a color temperature drift degree of the white image displayed by the RGBW display panel and the color temperature drift degree of the white image display by the original RGB display panel are identified, for improving a display effect of the RGBW display panel.

### BRIEF DESCRIPTION OF THE DRAWINGS

According to description with figures, features and advantages of embodiments of the disclosure will be clearer.

FIG. 1 is a structural schematic view of a color filter substrate according to an embodiment of the disclosure.

FIG. 2 is a spectrogram of each color of subpixels according to an embodiment of the disclosure.

FIG. 3 is a spectrogram of each color of subpixels according to an embodiment of the disclosure.

FIG. 4 is a curve diagram of a color temperature drift degree of a white image displayed by a RGBW display panel and a color temperature drift degree of a white image displayed by an initial RGB display panel.

FIG. 5 is a structural schematic view of a liquid crystal display according to an embodiment of the disclosure.

### DETAILED DESCRIPTION OF PREFERRED EMBODIMENTS

Embodiments of the disclosure will be described in detail with reference to the accompanying drawings as follows. However, the disclosure can be implemented in various forms, and the disclosure should not be explained to be restricted to the embodiments. In the contrary, the embodiments are provided to illustrate the principle of the disclosure and the practical application, so that a person skilled in the art can understand the embodiments of the disclosure and various modifications in specific situations.

In the accompanying drawings, thicknesses of a layer and a region are exaggerated for clarifying devices. A same label can represent a same component in the entire embodiments and figures.

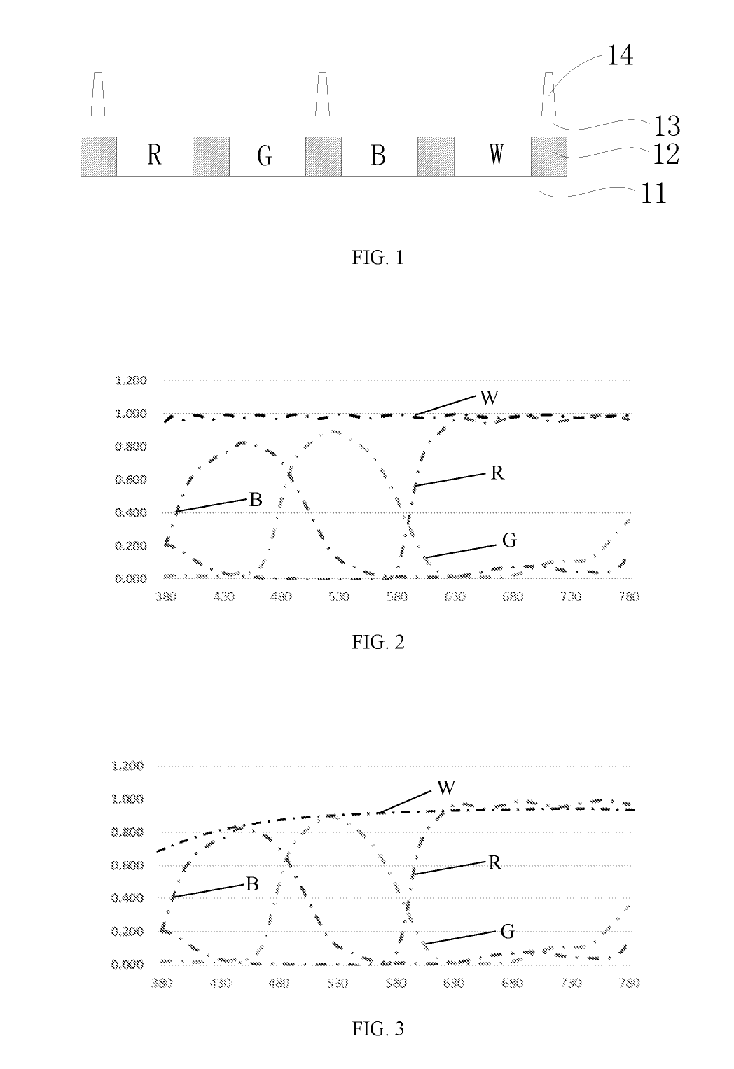

FIG. 1 is a structural schematic view of a color filter substrate according to an embodiment of the disclosure.

Referring to FIG. 1, a color filter substrate 1 according to the embodiment of the disclosure includes a substrate 11, a red subpixel R, a green subpixel G, a blue subpixel B and a white subpixel W, black matrixes 12, a conductive film layer 13 and photo spacers 14.

The red subpixel R, the green subpixel G, the blue subpixel B and the white subpixel W are disposed on the substrate 11 separately. Only one arrangement of the red subpixel R, the green subpixel G, the blue subpixel B and the white subpixel W on the substrate 11 is shown here, the disclosure does not limit arrangements of the subpixels with four colors.

As an embodiment of the disclosure, the red subpixel R can be formed by red photoresist material, the green subpixel G can be formed by green photoresist material, the blue subpixel B can be formed by blue photoresist material, the white subpixel W is formed by transparent photoresist material.

FIG. 2 is a spectrogram of each color subpixel according to an embodiment of the disclosure.

Referring to FIG. 2, when the white subpixel W is formed by the transparent photoresist material, a white chromaticity coordinate of a second white image merely displayed by the white subpixel W is (0.28, 0.29). A white chromaticity coordinate of a first white image displayed by the red subpixel R, the green subpixel G and the blue subpixel B and the white chromaticity coordinate of the second white image merely displayed by the white subpixel W are identified, or the white chromaticity coordinate of the first white image displayed by the red subpixel R, the green subpixel G and the blue subpixel B is also (0.28, 0.29).

As another embodiment of the disclosure, the red subpixel R can be formed by red photoresist material, the green subpixel G can be formed by green photoresist material, the blue subpixel B can be formed by blue photoresist material, the white subpixel W is formed by white photoresist material.

FIG. 3 is a spectrogram of each color subpixel according to an embodiment of the disclosure.

Referring to FIG. 3, when the white subpixel is formed by the white photoresist material, the white chromaticity coordinate of the second white image merely displayed by the white subpixel W is (0.3, 0.32). The white chromaticity coordinate of the first white image displayed by the red subpixel R, the green subpixel G and the blue subpixel B and the white chromaticity coordinate of the second white image merely displayed by the white subpixel W are identified, or the white chromaticity coordinate of the first white image displayed by the red subpixel R, the green subpixel G and the blue subpixel B is also (0.3, 0.32).

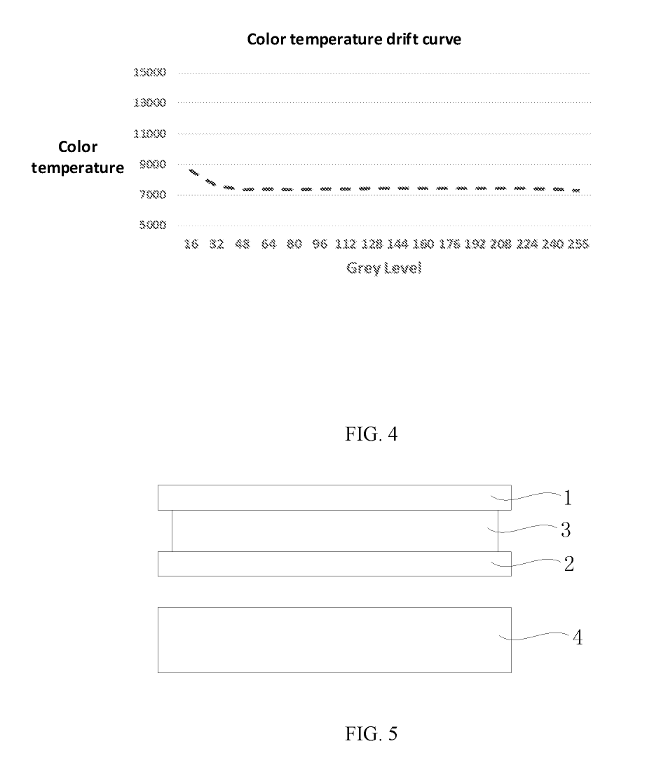

According to the two embodiments above, a color temperature drift degree of the white image displayed by the RGBW display panel with the additional white subpixel W and the color temperature drift degree of the white image display by the original RGB display panel can be identified, referring to FIG. 4 specifically. FIG. 4 is a curve diagram of a color temperature drift degree of a white image displayed by a RGBW display panel and a color temperature drift degree of a white image displayed by an initial RGB display panel. Referring to FIG. 4, a color temperature drift degree curve of the white image displayed by the RGBW display panel and a color temperature drift degree curve of the white image displayed by the original RGB display panel are coincidence, so that the color temperature drift degree of the white image displayed by the RGBW display panel and the color temperature drift degree of the white image displayed by the original RGB display panel are identified.

In the embodiment, the substrate 11 can be a transparent glass substrate, but the disclosure is not limited as such, the substrate 11 can also be a transparent resin substrate.

The black matrixes 12 are formed between any two adjacent subpixels. In the embodiment, the black matrixes are formed between the red subpixel R and the green subpixel G, the green subpixel G and the blue subpixel B, the blue subpixel B and the white subpixel W respectively.

The black matrixes 12 can be formed by black metal such as chromium, but the disclosure is not limited as such, for instance, the black matrixes 12 can also be formed by black resin.

The conductive film layer 13 covers the red subpixel R, the green subpixel G, the blue subpixel B, the white subpixel W and the black matrixes 12. In the embodiment, the conductive film layer 14 is formed by indium tin oxide ITO, but the disclosure is not limited as such. The conductive film layer 13 can be configured as a common electrode or a component with another function.

The photo spacers 14 are disposed on the conductive film layer 13 opposite to the black matrixes 12. After the color filter substrate 1 and an array substrate are aligned, the photo spacers 14 are configured to fix a distance between the two.

In the disclosure, numbers of the black matrixes 12, the red subpixel R, the green subpixel G, the blue subpixel B, the white subpixel W, the photo spacers 14 are not restricted as shown in FIG. 1, the numbers of which can be any number.

FIG. 5 is a structural schematic view of a liquid crystal display according to an embodiment of the disclosure.

Referring to FIG. 5, the liquid crystal display according to the embodiment of the disclosure includes a liquid crystal panel (with the color filter substrate 1, an array substrate 2 and a liquid crystal layer 3) and a backlight module 4 disposed opposite, the backlight module 4 provides display rays to the liquid crystal panel, so that the liquid crystal panel displays an image.

The liquid crystal panel includes the color filter substrate 1 as shown in FIG. 1 and the array substrate 2 that are aligned, and the liquid crystal layer 3 disposed between the two.

The array substrate 2 can be an amorphous silicon thin film transistor array substrate or a low temperature poly-silicon thin film transistor array substrate. The two sorts of array substrates can both be referred to the prior art, it is unnecessary to go into details.

Overall, according to the embodiments of the disclosure, the white chromaticity coordinate of the white image displayed by the white subpixel of the RGBW display panel and the white chromaticity coordinate of the white image displayed by the red subpixel, the green subpixel and the blue subpixel of the RGBW display panel are identified, so that the color temperature drift degree of the white image displayed by the RGBW display panel and the color temperature drift degree of the white image display by the original RGB display panel are identified, for improving a display effect of the RGBW display panel.

Although the disclosure is shown and described referring to the specific embodiments, it should be understood by a person skilled in the art that various alterations in forms and details can be achieved according to the protected scope defined by the claims and the equivalents of the disclosure.

What is claimed is:

1. A color filter substrate, comprising: a substrate, a red subpixel, a green subpixel, a blue subpixel and a white subpixel, the red subpixel, the green subpixel, the blue subpixel and the white subpixel disposed on the substrate;
the red subpixel, the green subpixel and the blue subpixel displaying a first white image, the white subpixel displaying a second white image, a white chromaticity coordinate of the first white image and a white chromaticity coordinate of the second white image identified.

2. The color filter substrate according to claim 1, wherein the red subpixel is formed by a red photo resistor, the green subpixel is formed by a green photo resistor, the blue subpixel is formed by a blue photo resistor, the white subpixel is formed by a white photo resistor or a transparent photo resistor.

3. The color filter substrate according to claim 2, wherein when the white subpixel is formed by the white photo resistor, the white chromaticity coordinates of the first white image and the second white image are (0.3, 0.32).

4. The color filter substrate according to claim 2, wherein when the white subpixel is formed by the transparent photo resistor, the white chromaticity coordinates of the first white image and the second white image are (0.28, 0.29).

5. The color filter substrate according to claim 1, wherein the color filter substrate further comprises: black matrixes formed between any two adjacent subpixels, the two subpixels comprise any two of the red subpixel, the green subpixel, the blue subpixel and the white subpixel.

6. The color filter substrate according to claim 5, wherein the color filter substrate further comprises: a conductive film layer, covering the red subpixel, the green subpixel, the blue subpixel, the white subpixel and the black matrixes.

7. The color filter substrate according to claim 6, wherein the color filter substrate further comprises: photo spacers, disposed on the conductive film layer opposite to the black matrixes.

8. A liquid crystal panel, comprising an array substrate and a color filter substrate that are aligned, the color filter substrate comprising: a substrate, a red subpixel, a green subpixel, a blue subpixel, a white subpixel, black matrixes, a conductive film layer, photo spacers, the red subpixel, the green subpixel, the blue subpixel and the white subpixel disposed on the substrate, the red subpixel formed by a red photo resistor, the green subpixel formed by a green photo resistor, the blue subpixel formed by a blue photo resistor, the white subpixel formed by a white photo resistor or a transparent photo resistor, the black matrixes formed between any two adjacent subpixels, the two subpixels being any two of the red subpixel, the green subpixel, the blue subpixel and the white subpixel, the conductive film layer covering the red subpixel, the green subpixel, the blue subpixel, the white subpixel and the black matrixes, the photo spacers disposed on the conductive film layer opposite to the black matrixes;
the red subpixel, the green subpixel and the blue subpixel displaying a first white image, the white subpixel displaying a second white image, a white chromaticity coordinate of the first white image and a white chromaticity coordinate of the second white image identified.

9. The liquid crystal panel according to claim 8, wherein the array substrate is an amorphous silicon thin film transistor array substrate or a low temperature poly-silicon thin film transistor array substrate.

10. The liquid crystal panel according to claim 8, wherein when the white subpixel is formed by the white photo resistor, the white chromaticity coordinates of the first white image and the second white image are (0.3, 0.32).

11. The liquid crystal panel according to claim 8, wherein when the white subpixel is formed by the transparent photo resistor, the white chromaticity coordinates of the first white image and the second white image are (0.28, 0.29).

12. A liquid crystal display, comprising a backlight module and a liquid crystal panel disposed opposite, the liquid crystal panel comprising an array substrate and a color filter substrate that are aligned, the color filter substrate comprising: a substrate, a red subpixel, a green subpixel, a blue subpixel, a white subpixel, black matrixes, a conductive film layer, photo spacers:
the red subpixel, the green subpixel, the blue subpixel and the white subpixel disposed on the substrate, the red subpixel formed by a red photo resistor, the green subpixel formed by a green photo resistor, the blue subpixel formed by a blue photo resistor, the white subpixel formed by a white photo resistor or a transparent photo resistor, the black matrixes formed between any two adjacent subpixels, the two subpixels being any two of the red subpixel, the green subpixel, the blue subpixel and the white subpixel, the conductive film layer covering the red subpixel, the green subpixel, the blue subpixel, the white subpixel and the black matrixes, the photo spacers disposed on the conductive film layer opposite to the black matrixes;
the red subpixel, the green subpixel and the blue subpixel displaying a first white image, the white subpixel displaying a second white image, a white chromaticity coordinate of the first white image and a white chromaticity coordinate of the second white image identified.

13. The liquid crystal display according to claim 12, wherein the array substrate is an amorphous silicon thin film transistor array substrate or a low temperature poly-silicon thin film transistor array substrate.

14. The liquid crystal display according to claim 12, wherein when the white subpixel is formed by the white photo resistor, the white chromaticity coordinates of the first white image and the second white image are (0.3, 0.32).

15. The liquid crystal display according to claim 12, wherein when the white subpixel is formed by the transparent photo resistor, the white chromaticity coordinates of the first white image and the second white image are (0.28, 0.29).
